(19) United States
(12) Patent Application Publication
(10) Pub. No.: US 2022/0379534 A1
(43) Pub. Date: Dec. 1, 2022

(54) MOLD FOR INJECTION MOLDING

(71) Applicant: Hella GmbH & Co. KGaA, Lippstadt (DE)

(72) Inventors: Dietmar Haut, Lippstdt (DE); Michael Lakenbrink, Oelde (DE)

(21) Appl. No.: 17/818,460

(22) Filed: Aug. 9, 2022

Related U.S. Application Data
(63) Continuation of application No. PCT/EP2020/054022, filed on Feb. 17, 2020.

(51) Int. Cl. B29C 45/37; B29C 33/56

(52) U.S. Cl. CPC B29C 45/37; B29C 33/56; B29K 2905/00; B29K 2995/007

(57) ABSTRACT

A Mold is provided for injection molding, for example for injection molding of optical components of automotive lighting devices. The mold includes a mold body with a coating applied on a surface of the mold body. The coating comprises electroless nickel.

### CROSS REFERENCE

This application claims priority to PCT Application No. PCT/EP2020/054022, filed Feb. 17, 2020, the entirety of which is hereby incorporated by reference.

### FIELD OF THE INVENTION

The present invention relates to a mold for injection molding, especially for injection molding of optical components of automotive lighting devices, comprising a mold body with a coating applied on a surface of the mold body.

### BACKGROUND OF THE INVENTION

Molds for injection molding comprise a mold body with a cavity, which represents the negative form of the parts to be manufactured. The surface of the mold body is subject to various requirements concerning e.g., surface quality, wear resistance or tribological properties. Therefore, the state-of-the-art comprises a large number of different approaches to tailor the properties of the mold body surface depending on the precise application, e.g., by mechanical treatments or by application of functional coatings.

In the field of automotive lighting devices, many optical components are commonly manufactured by means of injection molding, e.g., single lenses, micro-lens arrays, reflectors, diffusors, diffractive and holographic elements, anti-reflex structures, optical fibres, light guides, transparent housings or cover lenses. A crucial property of such optical components is their surface condition, which significantly determines the functionality of the components in terms of light manipulation. Smooth surfaces are required e.g., for highly efficient lenses or reflectors, whereas a precise roughness level or dedicated surface patterns are mandatory for light diffusing or diffracting elements. The surface condition of the molded optical components is directly determined by the surface condition of the respective molds, which therefore has to meet high quality requirements. Additionally, since optical components for automotive devices are typically mass products, the tool life of the molds, and especially their surface condition, should be very long-lasting.

Mold bodies are commonly machined from tool steel workpieces. A traditional treatment to finish the surface of the mold body is manual polishing in order to attain a preferably smooth surface. Such manually polished surfaces are generally inferior to coated surfaces because the manual treatment suffers from limited precision and reproducibility and may furthermore yield to undesired alterations of the surface contour. Coating technologies applied to mold surfaces in the state-of-the-art mainly comprise physical vapour deposition (PVD), chemical vapour deposition (CVD) or electroplating. Both PVD and CVD represent rather complex vacuum deposition methods and typically require a significant heating of the substrate in order to facilitate appropriate adhesion of the coating. Depending on the precise alloy used to manufacture the mold body, such heating during deposition might be detrimental to the mechanical properties, especially the hardness, of the mold body. Furthermore, PVD represents highly directional deposition methods, which are thus inappropriate for the application of homogeneous coatings on mold bodies with complex, three-dimensional shapes or surface patterns. Likewise, electroplating is also inappropriate to deposit coatings of homogeneous thickness on surfaces with complex topography or patterns due to corresponding local electric field variations during the deposition process.

### BRIEF SUMMARY OF THE INVENTION

It is an object of the present invention to provide an alternative embodiment of a mold for injection molding comprising a mold body with a coating applied on a surface of the mold body, which is especially appropriate for injection molding of optical components of automotive lighting devices, but not restricted to such applications.

The invention discloses the technical teaching that the coating applied to the mold body comprises electroless nickel.

Electroless nickel coatings are deposited by means of electroless plating. Electroless nickel plating is an autocatalytic method in which the reduction of nickel ions in a solution and the nickel coating deposition are carried out through the oxidation of a chemical compound present in the solution itself, i.e., a reducing agent like hydrated sodium hypophosphite, which supplies electrons. Unlike electroplating, it is not necessary to pass an electric current through the plating solution to form the nickel deposit. Electroless nickel plating creates homogeneous coatings regardless of the geometry of the mold body surface and can even be applied to non-conductive surfaces depending on the catalyst. Electroless nickel coatings exhibit a very dense microstructure and are thus appropriate as corrosion protection for the mold body. The composition of electroless nickel coatings comprises apart from nickel typically also a certain amount of phosphorous. Furthermore, co-deposition and incorporation of hard particles, e.g., Al₂O₃ or SiC, can lead to improved wear resistance and extended tool life of the inventive mold.

As a preferred embodiment of the invention, the coating features a thickness in the range of 2 μm to 50 μm. The precise choice of the coating thickness depends on the specific mold. If a smooth surface with minimum roughness is required, e.g., for injection molding of reflector elements, high-gloss decorative components or cover lenses, a high coating thickness is appropriate to cover and flatten the roughness of the mold body surface, which is typically machined by milling. On the other hand, a thin coating is useful to preserve and protect a micro-topography on the mold body surface, e.g., a dedicated pattern to mold a part for a holographic application.

Advantageously, the surface of the coating features a lower roughness level compared to the surface of the mold body. Roughness is generally defined as a surface deviation of third, fourth or fifth order, with characteristic length scales on the order of micrometers to nanometers. As stated above, a flat coating surface of low roughness level is mandatory for injection molding of optical components with smooth surfaces for reflective applications or low-loss light transmission. Furthermore, mold body surfaces with a desired microscopic topography can additionally feature an overlaid nanoscopic roughness, which yields to undesired light loss by diffraction in the molded optical components. Such nanoscopic roughness level can be reduced by the applied electroless nickel coating, even if the coating features only a thickness of few micrometers and preserves microscopic patterns of the mold body surface. Therefore, the surface of the coating advantageously features a lower nanoscopic roughness level and/or a lower microscopic roughness level compared to the surface of the mold body.

Advantageously, the surface of the coating features a root-mean-squared profile roughness in the range of 0.001 μm to 0.02 μm. The root-mean-squared profile roughness R_{q} is defined as follows. A roughness profile is filtered from the raw profile data and the mean line is. The roughness profile contains N equally spaced data points along the trace, and yᵢ is the vertical distance from the mean line to the i^{th} data point. Then:

$${R}_{q} = \sqrt{\frac{1}{N} {\sum }_{i = 1}^{N} {y}_{i}^{2}} .$$

Advantageously, the surface of the coating features an average absolute profile slope in the range of 0.01° to 0.5°. The average absolute profile slope R_{da} is defined as:

$${R}_{da} = \frac{1}{N} {\sum }_{i = 1}^{N} \vert {Δ}_{i} \vert ,$$

where Δᵢ is a Savitzky-Golay filter smoothed yᵢ data set calculated according to ASME B46.1

The range of profile roughness levels stated above especially yields appropriate mold surfaces for the injection molding of various optical components, e.g., of automotive lighting devices.

Advantageously, the surface of the coating features a lower waviness level compared to the surface of the mold body. Waviness is defined as surface deviations of second order, i.e., with characteristic length scales higher than roughness. Especially a coating with a high thickness is appropriate to reduce the waviness of the as-machined mold body surface.

According to another preferred embodiment of the invention, the electroless nickel comprises phosphorus at a portion in the range of 3 at. % to 14 at. % and/or 6 at. % to 9 at. %. Phosphorus is typically incorporated in electroless nickel coatings by using sodium hypophosphite in the bath solution. High phosphorus content in electroless nickel yields an amorphous microstructure of the coating with high corrosion-protection capability. Lower phosphorus content coatings feature higher hardness and wear resistance, both of which can be further enhanced by a heat treatment of the coating, which converts the amorphous coating microstructure into crystalline nickel and a hard nickel phosphide phase. Coatings of medium phosphorous content provide a suitable balance of corrosion-protection properties and hardenability. In industrial practise, corrosion issues in molding tools arise e.g., from leakage of tempering hoses or channels, or during transport from the manufacturer to the user.

Advantageously, the coating features a hardness in the range of 30 HRC to 80 HRC and/or 55 HRC to 70 HRC. Increased hardness level can be reached by appropriate heat treatment of the coating and provides a high resistance of the mold against mechanical wear and thus a prolonged tool life.

As a preferred embodiment of the invention, the mold body comprises a metallic material, e.g. a tool steel or an aluminium alloy or a copper-beryllium alloy. In case of a projected heat treatment of the electroless nickel coating, a metallic material of appropriate heat resistance has to be chosen. Furthermore, the chosen material preferably features a high corrosion resistance. Advantageously, the mold body features a hardness in the range of 20 HRC to 70 HRC. Increased hardness level provides a suitable persistence and durability of the mold body for use in mass production of mold injection components

### BRIEF DESCRIPTION OF THE DRAWINGS

Reference is now made more particularly to the drawings, which illustrate the best presently known mode of carrying out the invention and wherein similar reference characters indicate the same parts throughout the views.

FIG. 1 is a cross-section of a first embodiment of a mold.

FIG. 2 is a cross-section of a second embodiment of a mold.

### DETAILED DESCRIPTION OF THE DRAWINGS

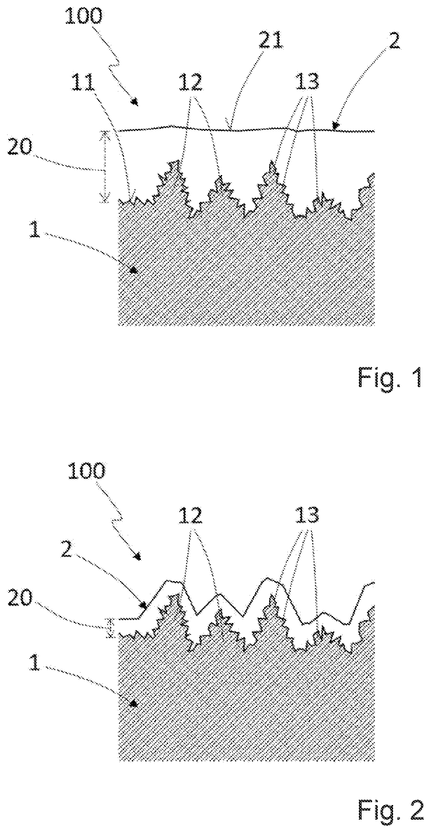

FIG. 1 and FIG. 2 show cross-sections of segments of inventive molds 100 each comprising the mold body 1 with the electroless nickel coating 2 applied to the surface 11 of the mold body 11. The surface 11 of the mold body 1 features both microscopic asperities 12 and nanoscopic asperities 13 representative of different orders of the surface roughness. Such different roughness orders stem for example from different machining processes applied to the mold body 1, e.g. milling or electrical discharge machining and/or subsequent grinding or manual polishing. Alternatively, the microscopic asperities 12 can be part of a dedicated surface pattern, which is intendedly structured into the surface 11 in order to generate a corresponding surface pattern on the molded part, e.g. for optical elements with light diffusing or light diffracting properties. The coating 2 yields a mirroring, high-gloss surface appearance of the mold 100.

The thickness 20 of the coating 2 is chosen according to the desired, application-specific surface topography of the coating 2 and/or the functionality of the coating 2 regarding the protection of the mold body 1 from mechanical wear and/or corrosion.

The embodiment of the mold 100 shown in FIG. 1 features a comparably thick coating 2, e.g. with a thickness 20 of about 10 μm to 50 μm, which exhibits a basically flat surface 21, thus smoothing the roughness of the underlying surface 11 of the mold body 1. The surface 21 of the coating essentially defines the surface quality of the parts injection-molded by the inventive mold 100 and the smooth surface 21 depicted in FIG. 1 is therefore especially appropriate for the manufacturing of optical components with even surfaces, e.g. base bodies for reflectors and decorative elements with thin metallic mirror coatings or for highly transparent lenses or covers panes.

FIG. 2. shows an embodiment of the mold 100 with a coating 2 of much lower thickness 20, e.g. about 2 μm to 20 μm. The coating 2 flattens the nanoscopic asperities 13 of the surface 11 of the mold body, but essentially preserves the contour of the microscopic asperities 12. The mold 100 is therefore dedicated for injection molding of optical components with patterned surfaces, e.g. diffusors or diffractive or holographic elements.

The present invention is not limited by the embodiment described above, which is represented as an example only and can be modified in various ways within the scope of protection defined by the appending patent claims.

### LIST OF NUMERALS

100 mold
1 mold body
11 surface (of the mold body)
12 microscopic asperity
13 nanoscopic asperity
2 coating
20 thickness (of the coating)
21 surface (of the coating)

We claim:

1. A mold for injection molding comprising:
a mold body having a surface;
a coating applied on the surface of the mold body,
wherein the coating comprises electroless nickel.

2. The mold according to claim 1, wherein the coating has a thickness in the range of 2 μm to 50 μm.

3. The mold according to claim 1, wherein a surface of the coating features a lower roughness level compared to the surface of the mold body.

4. The mold according to claim 3, wherein the surface of the coating features a lower nanoscopic roughness level and/or a lower microscopic roughness level compared to the surface of the mold body.

5. The mold according to claim 3, wherein the surface of the coating has a root-mean-squared profile roughness in a range of 0.001 μm to 0.02 μm.

6. The mold according to claim 3, wherein the surface of the coating has an average absolute profile slope in a range of 0.01° to 0.5°.

7. The mold according to claim 3, wherein the surface of the coating has a lower waviness level compared to the surface of the mold body.

8. The mold according to claim 1, wherein the electroless nickel comprises phosphorus at a portion in the range of 3 at. % to 14 at. %.

9. The mold according to claim 1, wherein the coating features a hardness in the range of 30 HRC to 80 HRC.

10. The mold according to claim 1, wherein the mold body comprises a metallic material.

11. The mold according to claim 1, wherein the mold body has a hardness in the range of 20 HRC to 70 HRC.

12. The mold according to claim 1, wherein the electroless nickel comprises phosphorus at a portion in the range of 6 at. % to 9 at. %.

13. The mold according to claim 1, wherein the coating features a hardness in the range of 65 HRC to 75 HRC.
